(19) United States
(12) Patent Application Publication
(10) Pub. No.: US 2008/0044531 A1
(43) Pub. Date: Feb. 21, 2008

(54) Juice processing

(75) Inventors: Daniel J. Blase, St. Louis, MO (US); Cheriyan B. Thomas, Ellington, CT (US)

Correspondence Address: MUELLER AND SMITH, LPA;MUELLER-SMITH BUILDING, 7700 RIVERS EDGE DRIVE, COLUMBUS, OH, 43235, US

(73) Assignee: Innovative Product Management, LLC, Ellington, CT (US)

(21) Appl. No.: 11/881,364

(22) Filed: Jul. 26, 2007

Related U.S. Application Data
(63) Continuation-in-part of application No. PCT/US06/03149, filed on Jan. 27, 2006.
(60) Provisional application No. 60/648,183, filed on Jan. 28, 2005.

(51) Int. Cl. A23L 2/00; A23C 9/00; A23L 2/02; C12G 3/00

(52) U.S. Cl. 426/330.4; 426/330; 426/330.3; 426/330.5; 426/580; 426/583; 426/590; 426/599

(57) ABSTRACT

A method for treating a sugar-containing (e.g., sucrose, fructose, glucose) beverage (e,g., fruit juice, vegetable juice) includes passing a stream of a beverage into contact with a packed bed capable of selectively removing sugar from the beverage and separating a sugar-diminished beverage from the packed bed. A high intensity natural and/or artificial sweetener can be added to the sugar-diminished beverage to produce a beverage product having similar flavor and nutritional content as the original beverage, but containing a lower amount of calories. The sugar-reduced beverage also can be used as a flavoring for the beverage and food industry; or as an ingredient component for reduced and full calorie foods (e.g., jellies, candies, etc.). The sugar-reduced beverage can be concentrated to a higher level using less energy as compared to standard juices. The resulting concentrate also realizes significant frozen storage and shipping costs compared to standard juice concentrates.

### CROSS-REFERENCE TO RELATED APPLICATIONS

This application claims benefit of PCT application serial number PCT/US2006/003149 filed on Jan. 27, 2006, which claims priority on U.S. provisional application Ser. No. 60/648,183 filed on 28 Jan. 2005.

### STATEMENT REGARDING FEDERALLY SPONSORED RESEARCH

Not applicable.

### BACKGROUND

The present disclosure relates generally to processing of a variety of ingestible liquid (fluent or flowable) beverages and more particularly to such beverages being substantially devoid of sugars.

Fruit and vegetable juices are widely used in the food and beverage industry as a juice, juice beverage, flavor, and/or ingredient component. A juice typically is defined by its brix content and is used either as single strength juice or juice concentrate. A “juice beverage” is defined as any product that contains a juice, but may contain less than 100% juice.

Juices are an excellent source of vitamins, minerals and other beneficial compounds. However, an 8-ounce (240 ml) glass of orange juice, for example, contains 110 calories, primarily from the 22 grams of sugar. Obesity and diabetes in the US are moving consumers towards low sugar, low calorie beverages. Although juice products have a high nutritional content, there has been a sharp decline in juice consumption recently due partially to its high calorie and sugar content. Today's low calorie juice beverages are primarily diluted juices with juice flavoring and do not contain the nutritional benefits of the natural whole juice.

Orange juice, as with most fruit and vegetable juices, is defined and regulated by its standard of identity. This is based on the brix (soluble solids; including fructose, sucrose, and glucose) of the juice. “Brix” is a refractive! index scale for measuring the amount of sugar in a solution at a given temperature.

In particular, squeezing the liquid from the orange produces “Orange Juice”. The resulting juice is passed through a centrifuge or other process to remove small pieces of orange peel and excess pulp.

Orange Juice Concentrate is produced by passing finished juice over a heat exchanger to remove most (about 80% to about 90%) of the native water. The orange juice concentrate is stored frozen until needed. Frozen concentrate is shipped domestically and internationally to local and regional beverage plants where it is reconstituted (water is returned to the concentrate) to produce “Orange Juice” (100% Orange Juice; based on standard of identity) and “Orange Juice Beverages” (less then 100% Orange Juice; based on standard of identity). This process of juice concentration has a high-energy requirement and is, therefore, expensive. Frozen concentrate storage and shipment also is expensive due to its bulk.

Orange Juice also is sold as a single strength product and is labeled for the retail market as “Orange Juice not from Concentrate”. It is sold at El premium due to the higher quality, additional storage and transportation cost (single strength versus concentrate), and special (expensive) storage requirements.

In the present application, then, the terms “Orange Juice” arid “Orange Juice Concentrate” will be used to signify their standard of identity.

There has not been any significant innovation in the juice industry in many years. The disclosed process will enable significant increase in juice consumption and provide an alternative to the traditional juices and the juice beverage due to the removal of unwanted sugars with retention of flavor and nutritional components.

Fruit and vegetable juices typically are used to produce flavor and ingredient components to enhance the natural qualities of consumer products. For example, orange juice could be added to a beverage to enhance the citrus flavor. Vegetable juices are added to foods to impart their natural flavor profile.

### BRIEF SUMMARY

Disclosed is a method for producing a low sugar (e.g., sucrose, fructose, glucose, etc.) fruit juice, vegetable juice, flavor ingredient, or dairy product (hereinafter, “LSP”) by contacting the LSP stream with a bead that selectively adsorbs sugars from the LSP to produce a sugar-reduced LSP stream and a sugar-rich stream. The resulting LSP stream can be used to produce, for example, a juice beverage, juice concentrate, flavoring, and/or ingredient component. In its broadest context, a “natural consumable product” will be treated for making a sugar-reduced consumable product suitable for use as a beverage, flavoring, ingredients, or (food) additive/supplement including dietary and nutritional supplements.

An organoleptically acceptable beverage can be produced from the sugar-reduced LSP stream by adding thereto a high intensity natural and/or artificial sweetener (e.g., sucralose, aspartame, saccharine, or the like) and/or a sugar (e.g., HFCS, sucrose, fructose, glucose, or the like). By adding a reduced calorie sweetener, a reduced calorie beverage is produced. This beverage will have most of the nutritional benefits of the original fruit or vegetable without the calories, since the sugar has been removed. It should be understood that not all of the sugar needs to be removed from the beverage subjected to the resin bed treatment, as only partial removal of sugar reduces the calories of the beverage.

The sugar-reduced LSP stream also can be used as a flavoring in beverages or foods, or as a replacement for single strength LSP where the LSP is added primarily for the flavor and nutrition contribution. Sugar-reduced LSP also can be used as an ingredient for low calorie products (e.g., jellies, fillings, fruit preps, candies, cakes, or the like.).

Sugar-reduced LSP further can be concentrated by 10%-90% or more. This concentrate results in a significant reduction in volume compared to standard juice concentrates due to the reduction of sugars. Processing cost of concentrating juices is reduced significantly due to the lack of sugars in the juice streams. Sugar reduced LSP concentrates would result in significant less frozen shipping and frozen storage cost compared to standard concentrates due to the lower volume. Thermal, flavor, and nutritional degradation of the juice also is reduced since the concentration process requires less heat and time

The process includes one or more of the following benefits;
1. Low calorie beverage,
2. Low sugar beverage,
3. Beverage with similar nutritional content as the original juice with less sugar or calories,
4. Lower processing costs during the concentration process,
5. Lower frozen storage costs,
6. Lower frozen shipment costs,
7. Higher quality concentrates and beverages,
8. Lower bulk frozen flavor,
9. Lower bulk frozen ingredient.

### BRIEF DESCRIPTION OF THE DRAWINGS

For a fuller understanding of the nature and advantages of the present disclosure, reference should be made to the following detailed description taken in connection with the accompanying drawings, in which:

FIG. 1 is a simplified schematic flow diagram showing how the inventive process can be practiced; and

FIGS. 2, 3, and 4 graphically plot Brix versus tube number for the tests reported in the Examples.

The drawing will be described in further detail below.

### DETAILED DESCRIPTION

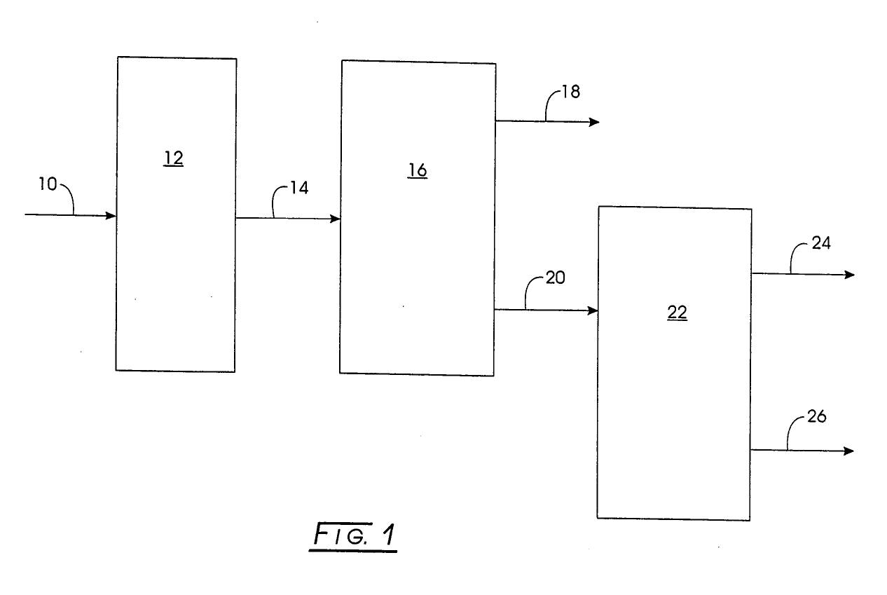

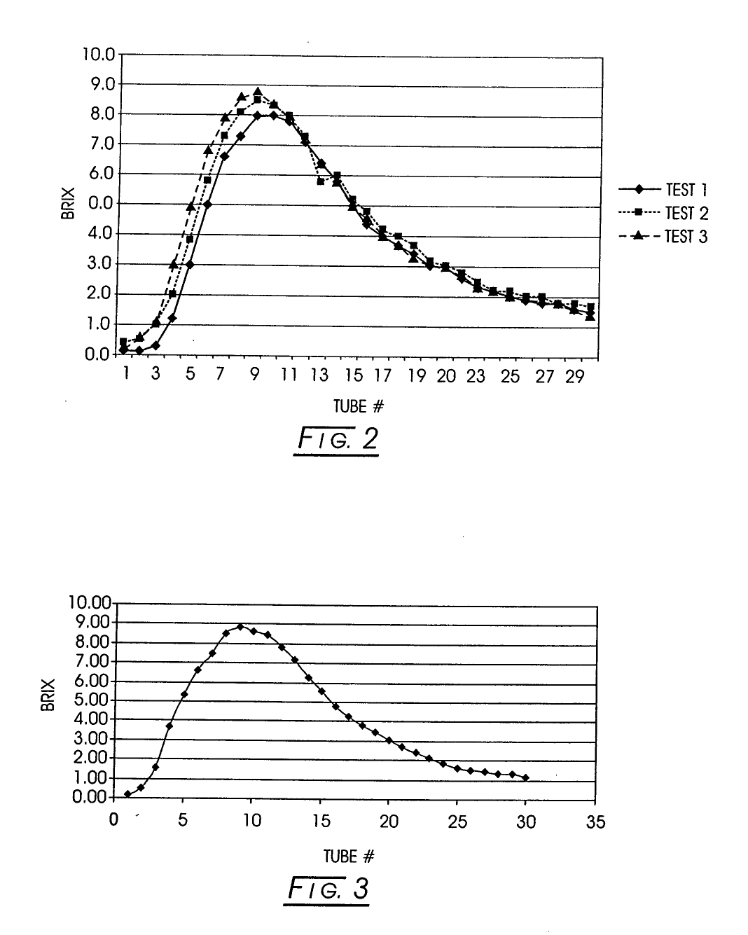

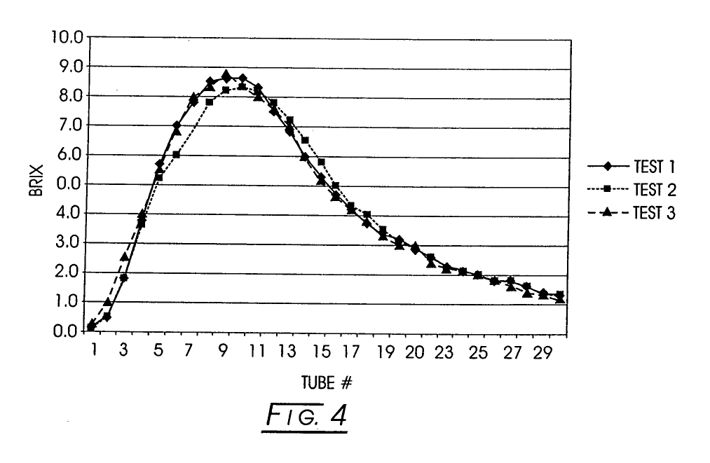

Referring to FIG. 1, finished “Orange Juice”, 10, is passed though a centrifuge, 12, to remove most, if not all, of the pulp. The juice stream is subsequently passed through a filter (e.g., hollow fiber filter) to remove most of the pectin. The resulting juice, 14, is passed though a column, 16, of resin beads (which has a high affinity for sugars) and which selectively retains sugars. The resins, such as, for example, DOWEX MONOSPHERE 99 CA (supplied by Dow Chemical Company, Midland, Mich.) and DIAION UBK 555 (supplied by Mitsubishi Chemical Corporation) can be used. The sugar is adsorbed onto the resin and, therefore, is separated to produce a sugar-starved juice stream, 18, and a sugar-rich resin, 20. Sugar rich resin 20, then, is regenerated in a regeneration zone, 22, resulting in a sugar stream, 24, and resin beads, 26, available for recycle to column 16. Columns can be run in series, parallel, cascade, or the like, in conventional fashion for additional treating time, capacity, or for special affects. Potassium, sodium, and other forms of the resin also can be used. The resulting products are:

(1) an “Orange Juice without Sugar” stream; and

(2) a “Sugars” stream.

The first stream, Orange Juice diminished in sugar 18, no longer meets the standard of identity for “Orange Juice”. This stream can be used for producing, but not limited to:
1. orange Juice beverages;
2. low sugar/low calorie “Orange Juice Beverage with High Intensity Sweeteners”;
3. low sugar/low calorie “Orange Juice Flavor”;
4. low sugar/low calorie “Orange Juice Ingredient”;
5. low sugar/low calorie “Orange Juice Beverage Concentrate with High Intensity Sweeteners”;
6. low sugar/low calorie “Orange Juice Flavor Concentrate”;
7. low sugar/low calorie “Orange Juice Ingredient Concentrate”;
8. Juice concentrates (Orange Juice without sugar recombined with sugars).

Sugar stream 24 can be used for sweetening a variety of foodstuffs, including sugar-starved juice stream 18. Additionally, recovered resin beads 26 can be recycled to column 16 or a similar column for reuse in treating additional juice 14.

While a continuous process utilizing a packed bed column is illustrated in the drawings, the process can be practiced by a batch process using a fixed/packed bed reactor, a fluidized bed reactor, simulated moving bed (SMB), ion exchange and adsorption unit (e.g., ISEP unit of Calgon Carbon Corporation), chromatography separator (e.g., CSEP of Calgon Carbon Corporation), or any suitable reactor or vessel capable of containing the bed of sugar adsorbing material and permitting contact of a sugar-containing beverage with the adsorbent for a time adequate for some sugar to be adsorbed and a beverage diminished in sugar content withdrawn from the reactor vessel. Thus, the inventive process should be construed broadly in terms of adsorbent and reaction vessel, so long as a sugar-diminished LSP stream is withdrawn from such vessel.
1. Juice may be pre-processed to reduce the level of pulp, pectin or other components, which may interfere with the separation process.
2. The process may include filtration by hollow fiber, ultra filtration or other methods to reduce pulp, pectin or other components
3. The process results in a beverage with similar nutritional content as the original juice with less sugar or calories.
4. The process results in a flavor.
5. The process results in an ingredient component.
6. The process results in a concentration process, which significantly reduces thermal processing to concentrate the product.
7. The process results in a concentration process, which has a lower cost.
8. The process results in a concentrate, which reduces frozen storage cost.
9. The process results in a concentrate, which reduces frozen shipping cost.
10. The process results in a concentrate, which reduces aseptic processing requirements (volume and cost).
   Benefits to the Consumer

A beverage containing the LSP without-sugars, water, and a high intensity natural and/or artificial sweetener (i.e., sucralose or the like) produces a beverage that is parity in sensory evaluations versus standard “LSP”. The resulting beverage will contain most of the vitamins, minerals, and other beneficial compounds of “LSP” without the calories from sugar. Citrus pectin or some other carbohydrate (gums, etc.) may be added to give additional viscosity and mouth-feel.

Orange Juice consumption is declining in part due to the high calories of the beverage. A low calorie product will allow consumers the opportunity to consume a beverage with the goodness of Orange Juice without worry of additional calories of standard orange juice. Some of the benefits to the consumer are as follows;
1. Low calorie “Juice Beverage”.
2. Low sugar “Juice Beverage”.
3. “Juice Beverage” similar in nutrition to the standard juice, without all the sugar or calorie.
4. Higher quality concentrates and beverages.
5. Be able to drink more “juice” containing products.
   Benefit to the Manufacturer

LSP without-sugar can be used to produce LSP without sugar concentrates, LSP without-sugar flavor (i.e., beverages, etc.) and LSP without-sugar ingredient components (i.e., candies, etc.)

Concentrating LSP is very expensive, partially due to the high sugar content resulting in high viscosity and high-energy requirements. By using sugar-reduced LSP (low soluble solids), energy requirement will be significantly reduced. Less energy is required to concentrate low soluble solid solutions versus high soluble solid solutions. This thermal processing savings can range from about 10% to about 50% or even higher. The resulting sugar-reduced LSP concentrate can be recombined with water and high intensity sweeteners to produce low calorie beverages.

Sugar-reduced LSP storage and shipping costs (frozen and refrigerated) for single strength and concentrate are significantly reduced by removing sugar. This savings can range from about 10% to about 70% or even higher.

The disclosed processing can be used with other fruit juices and vegetable juices, including, inter alia, cranberry, citrus, grape, apple, pineapple, tomato, carrot juice, etc.

The disclosed processing also can be used to produce low calorie beer, wine, wine coolers, and other alcoholic beverages by removing sucrose, fructose, glucose, dextrins, and/or other simple sugars. Flavor parity can be achieved by introducing high intensity sweeteners, pectin, etc.

“Beverage”, then, for present purposes is a broad term, comprehending a sugar-containing fluent (flowable) consumable product, including, for example, fruit juice, vegetable juice, alcoholic beverage, dairy product, and the like. Sugars for removal will depend upon the beverage and includes, inter alia, mono-saccharides, di-saccharides, and poly-saccharides. Appropriate beads for such selective sugar removal will be chosen based on the specific sugars and beverages being treated and include, inter alia, resins, ceramics, inorganics, and like beads, often presented as a packed bed. Following are some of the benefits to the manufacturer.
1. Market a new low calorie beverage with true consumer benefits.
2. Market a new low sugar beverage with true consumer benefits.
3. Market a new beverage similar in nutrition to the standard juice, without all the sugar or calorie.
4. Higher quality concentrates and beverages.
5. Lower processing costs during the concentration process.
6. Lower frozen storage costs.
7. Lower frozen shipment costs.
8. Lower aseptic processing requirement (volume and cost).
9. Market New products such as, for example,
   a. LSP beverages;
   b. low sugar/low calorie LSP Beverage with High Intensity Sweeteners”;
   c. low sugar/low calorie “LSP Flavor”;
   d. low sugar/low calorie “LSP Ingredient”;
   e. low sugar/low calorie “LSP Beverage Concentrate with High Intensity Sweeteners”;
   f. low sugar/low calorie “LSP Flavor Concentrate”;
   9. low sugar/low calorie “LSP Ingredient Concentrate”;
   h. Juice concentrates (LSP without sugar recombined with sugars).

The following examples show how the present process has; been practiced, but they should not be construed as limiting. In this application all units are in the metric system and all amounts and percentages are by weight, unless otherwise expressly indicated.

### EXAMPLES

### Objective

Separate (fractionate) sugars from fructose solution, Orange Juice and Apple Juice, using Dowex® Monosphere® 99CA/320 Separation Resin.

### Experimental Procedure

Resin Conditioning:

Dowex® Monosphere® 99CA/320 Separation Resin (Supelco Inc.) was conditioned by transferring moist resin to a glass container with distilled water. The resin was mixed slowly in the water and allowed to set for 3 minutes before the supernatant was decanted. The procedure was repeated three times before the resin was considered conditioned.

Column Preparation:

Conditioned Dowex® Monosphere® 99CA/320 Separation Resin slurry was added to a column containing 30 cm of distilled water. The outlet tube was opened to prevent overflow and additional resin was added to continue packing the column. Packing of the resin bed was a continuous process in order to produce a homogeneous column. The water level was maintained above the resin surface throughout this process. The final resin bed height was 63.5 cm with a diameter of 3 cm.

Sample Preparation:

Three samples were prepared. The first sample was a fructose solution to simulate a simple juice without native pulp, pectin, or other materials that may interfere with separation. The second and third samples were clairified Orange Juice and commercially available Apple Juice concentrate, respectively.

The fructose solution was prepared by combining 144 gm crystalline fructose, 200 ml of room temperature distilled water (Great Value), and one drop of blue color (McCormick Neon Food Colors). The solution was manually stirred until the crystalline fructose was dissolved. The resulting solution had a brix of 42.3° as measured with a hand held refractometer (Epic Inc, 30%-60%).

Clarified Orange Juice concentrate (Cargill Inc.) was tempered to 73° F. and stirred to maintain a homogenous sample. The Clarified Orange Juice Concentrate was determined to be 68.2° brix as measured with a hand held refractometer (Epic Inc, 30%-60%). The clairified concentrate was diluted with distilled water to a final brix of 42.0°.

Apple Juice concentrate (Langers 100% Apple Juice) was tempered to 73° F. and stirred to maintain a homogenous sample. The Apple Juice was determined to be 42.3° brix as measured with a hand held refractometer (Epic Inc, 30%-60%).

Fractionation Procedure:

The water level was lowered to the surface of the resin before a 30 ml sample of the test solution was added to the top of the column. Once the entire sample entered the resin bed, the elutant was collected. After 125 ml of elutant was collected, the remaining liquid was collected manually in glass test tubes. Thirty, 10.3 ml samples were collected from each test. The column was reconditioned by passing 200 ml of distilled water after each test. The three samples, Fructose solution, Orange Juice, and Apple Juice, were run in triplicate. The column flow rate was maintained at 37 ml/min. for all tests.

Results:

The Fructose solution was fractionated from the blue color and fructose (Table 1). Tubes 3 and 4 showed the maximum color. Tube #9 showed the highest brix, as measured with a hand held refractometer (Reichert model 10430 0-30 Brix). The trial was run in triplicate and the resulting data shows very good correlation between tests (Table 1).

Orange Juice was fractionated into “juice without sugars” and sugars (Table 2). Tube #4 showed the maximum orange color, orange flavor, and aroma. Tube #9 showed the highest brix, as measured with a hand held refractometer (Reichert model 10430 0-30 Brix). The Orange Juice trial was run in triplicate and the resulting data shows very good duplication (Table 2).

Apple Juice was fractionated into “juice without sugar” and sugar (Table 3). Tube #4 showed the maximum brown color, apple flavor, and aroma. Tube #9 showed the highest brix, as measured with a hand held refractometer (Reichert model 10430 0-30 Brix). The Apple Juice trial was run in triplicate and the resulting data shows very good duplication (Table 3).

### CONCLUSION

Fructose was separated from the fructose solution and sugars were separated from Orange Juice and Apple Juice with a DOWEX® IONOSPHERE® 99CA/320 separation resin column.

The “orange juice without sugars” fractions contained orange color, orange flavor, and aroma, while the sugars containing tubes had minimal color, orange flavor, and aroma.

The “apple juice without sugar” fractions contained brown color, apple flavor, and aroma, while the sugar containing tubes had minimal color, apple flavor, and aroma.

The process and system can be modified, for example, by using various resin type, resin size, resin porosity, column dimensions, flow rate, sample size, fluidized and packed bed etc. and, thereby, efficiently remove sugars from LSP to achieve the desired sugar content. Cationic, Anionic, and Ion Exclusion Resins as well as other resins commercially available can be used.

TABLE 1
Crystalline Fructose (Brix)

| Tube | Test 1 | Test 2 | Test 3 |
|---|---|---|---|
| 1 | 0.1 | 0.4 | 0.3 |
| 2 | 0.1 | 0.5 | 0.6 |
| 3 | 0.3 | 1.0 | 1.1 |
| 4 | 1.2 | 2.0 | 3.0 |
| 5 | 3.0 | 3.8 | 4.9 |
| 6 | 5.0 | 5.8 | 6.8 |
| 7 | 6.6 | 7.3 | 7.9 |
| 8 | 7.3 | 8.1 | 8.6 |
| 9 | 8.0 | 8.5 | 8.8 |
| 10 | 8.0 | 8.3 | 8.4 |
| 11 | 7.8 | 8.0 | 8.0 |
| 12 | 7.1 | 7.3 | 7.2 |
| 13 | 6.4 | 5.8 | 6.4 |
| 14 | 5.8 | 6.0 | 5.8 |
| 15 | 5.0 | 5.2 | 5.0 |
| 16 | 4.4 | 4.8 | 4.6 |
| 17 | 4.0 | 4.2 | 4.0 |
| 18 | 3.7 | 4.0 | 3.7 |
| 19 | 3.4 | 3.7 | 3.3 |
| 20 | 3.0 | 3.2 | 3.1 |
| 21 | 3.0 | 3.0 | 3.0 |
| 22 | 2.6 | 2.8 | 2.7 |
| 23 | 2.3 | 2.5 | 2.3 |
| 24 | 2.2 | 2.2 | 2.2 |
| 25 | 2.0 | 2.2 | 2.0 |
| 26 | 1.9 | 2.0 | 2.0 |
| 27 | 1.8 | 2.0 | 1.9 |
| 28 | 1.8 | 1.8 | 1.8 |
| 29 | 1.6 | 1.8 | 1.6 |
| 30 | 1.5 | 1.7 | 1.4 |

TABLE 2
Orange Juice (Brix)

| Tube | Test 1 | Test 2 | Test 3 |
|---|---|---|---|
| 1 | 0.1 | 0.3 | 0.2 |
| 2 | 0.4 | 0.5 | 0.6 |
| 3 | 1.6 | 1.7 | 1.4 |
| 4 | 3.7 | 3.5 | 3.9 |
| 5 | 5.4 | 5.3 | 5.3 |
| 6 | 6.8 | 6.5 | 6.5 |
| 7 | 7.2 | 7.6 | 7.6 |
| 8 | 8.4 | 8.7 | 8.5 |
| 9 | 8.6 | 9.0 | 8.9 |
| 10 | 8.4 | 8.8 | 8.7 |
| 11 | 8.3 | 8.7 | 8.3 |
| 12 | 7.9 | 7.7 | 7.8 |
| 13 | 7.3 | 7.1 | 7.1 |
| 14 | 6.1 | 6.3 | 6.4 |
| 15 | 5.5 | 5.6 | 5.6 |
| 16 | 4.6 | 4.9 | 4.8 |
| 17 | 4.1 | 4.2 | 4.4 |
| 18 | 3.6 | 3.9 | 3.8 |
| 19 | 3.4 | 3.5 | 3.4 |
| 20 | 3.0 | 3.1 | 3.0 |
| 21 | 2.6 | 2.8 | 2.7 |
| 22 | 2.5 | 2.4 | 2.3 |
| 23 | 2.2 | 2.1 | 2.0 |
| 24 | 1.9 | 1.9 | 1.8 |
| 25 | 1.6 | 1.7 | 1.6 |
| 26 | 1.5 | 1.6 | 1.4 |
| 27 | 1.4 | 1.5 | 1.4 |
| 28 | 1.3 | 1.4 | 1.3 |
| 29 | 1.3 | 1.4 | 1.3 |
| 30 | 1.2 | 1.3 | 1.0 |

TABLE 3
Apple Juice (Brix)

| Tube | Test 1 | Test 2 | Test 3 |
|---|---|---|---|
| 1 | 0.2 | 0.1 | 0.3 |
| 2 | 0.4 | 0.5 | 1.0 |
| 3 | 1.8 | 1.8 | 2.6 |
| 4 | 3.8 | 3.6 | 4.0 |
| 5 | 5.7 | 5.2 | 5.5 |
| 6 | 7.0 | 6.0 | 7.0 |
| 7 | 7.8 | 6.8 | 8.0 |
| 8 | 8.5 | 7.8 | 8.3 |
| 9 | 8.6 | 8.2 | 8.8 |
| 10 | 8.6 | 8.3 | 8.3 |
| 11 | 8.3 | 8.2 | 8.0 |
| 12 | 7.5 | 7.8 | 7.6 |
| 13 | 6.8 | 7.2 | 7.0 |
| 14 | 6.0 | 6.5 | 6.0 |
| 15 | 5.3 | 5.8 | 5.2 |
| 16 | 4.7 | 5.0 | 4.6 |
| 17 | 4.2 | 4.3 | 4.2 |
| 18 | 3.7 | 4.0 | 3.8 |
| 19 | 3.3 | 3.5 | 3.3 |
| 20 | 3.2 | 3.1 | 3.0 |
| 21 | 2.8 | 2.9 | 3.0 |
| 22 | 2.6 | 2.6 | 2.4 |
| 23 | 2.3 | 2.2 | 2.2 |
| 24 | 2.1 | 2.1 | 2.1 |
| 25 | 2.0 | 2.0 | 2.0 |
| 26 | 1.8 | 1.8 | 1.8 |
| 27 | 1.8 | 1.8 | 1.6 |
| 28 | 1.6 | 1.6 | 1.4 |
| 29 | 1.4 | 1.3 | 1.3 |
| 30 | 1.3 | 1.3 | 1.2 |

While the process and products have been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the disclosure not be limited to the particular embodiments disclosed, but that the disclosure will include all embodiments falling within the scope of the appended claims. All citations referred herein are expressly incorporated herein by reference.

We claim:

1. A method for treating a sugar-containing natural consumable product for lowering its sugar content, comprising the steps of:
(a) passing a stream of a natural consumable product into contact with a bed of ionic adsorbent material capable of selectively removing sugar from the natural consumable product; and
(b) separating a sugar-diminished natural consumable product from the adsorbent bed.

2. The method of claim 1, wherein said natural consumable product is one or more of a beverage, flavoring, food ingredient, or dietary supplement, or nutritional supplement.

3. The method of claim 1, wherein said sugar is one or more of a mono-saccharide, di-saccharide, or poly-saccharide.

4. The method of claim 3, wherein said sugar is one or more of sucrose, fructose, or glucose.

5. The method of claim 4, wherein said natural consumable product is one or more of a fruit juice, vegetable juice, an alcoholic beverage, or a dairy product.

6. The method of claim 5, wherein said juice is a citrus juice or a berry juice.

7. The method of claim 5, wherein said juice is one or more of orange juice, cranberry juice, grape juice, apple juice, pineapple juice, tangerine juice, grapefruit juice, pomegranate juice, cherry juice, strawberry juice, tomato juice, celery juice, or carrot juice; and said alcoholic beverage is one or more of wine, wine cooler, or beer.

8. The method of claim 5, wherein said natural consumable product is one or more of milk, yogurt, cheese, or cottage cheese; and said sugar comprises lactose.

9. The method of claim 1, wherein said sugar-diminished natural consumable product in step (b) is subjected to step (a) a plurality of times.

10. The method of claim 1, wherein said bed is one or more of resinous beads, organic beads, ceramic beads, or inorganic beads.

11. The method of claim 1, wherein said adsorbent bed is housed in a vessel through which said stream is passed.

12. The method of claim 1, which is one or more of a batch process, semi-continuous process, or continuous process using a packed bed reactor, simulated moving bed, ion exchange and adsorption reactor, chromatography separator, or a fluidized bed reactor.

13. The method of claim 1, wherein said material is one or more of ionic beads, affinity beads, or size exclusion beads.

14. The method of claim 1, wherein said stream in step (a) has been pretreated to one or more reduce the level of a component, dilute said stream, or concentrate said stream.

15. A sugar-diminished beverage prepared by the process of claim 1.

16. A sugar-diminished beverage prepared by the process of claim 2.

17. A sugar-diminished beverage prepared by the process of claim 5.

18. A sugar-diminished beverage prepared by the process of claim 6.

19. A sugar-diminished beverage prepared by the process of claim 7.

20. A sugar-diminished beverage prepared by the process of claim 8.

21. A sugar-diminished beverage prepared by the process of claim 9.
